(19) United States
(12) Patent Application Publication
(10) Pub. No.: US 2025/0300854 A1
(43) Pub. Date: Sep. 25, 2025

(54) PROGRESSIVE VOLTAGE CHANGE IN A SINGLE-WIRE BUS CIRCUIT

(71) Applicant: Qorvo US, Inc., Greensboro, NC (US)

(72) Inventors: Christopher Truong Ngo, Queen Creek, AZ (US); Daniel Charles Kerr, Oak Ridge, NC (US)

(21) Appl. No.: 18/614,860

(22) Filed: Mar. 25, 2024

(51) Int. Cl. H04L 12/40; G06F 13/42; H04L 12/403

(52) U.S. Cl. CPC H04L 12/40019; G06F 13/4291; H04L 12/403

(57) ABSTRACT

A single-wire bus circuit is provided. Herein, a master circuit is configured to communicate bus telegrams with multiple slave circuits over the single-wire bus. Each of the bus telegrams starts with a start-of-sequence (SOS) sequence. The master circuit is configured to signal a start of the SOS sequence by pulling the single-wire bus from a higher voltage to a lower voltage. In order to overcome a combined resistance of the single-wire bus and the multiple slave circuits, the master circuit must pull the single-wire bus down with a strong enough drive strength that may inadvertently cause bus ringing in the single-wire bus circuit. In embodiments disclosed herein, the master circuit is configured to pull the single-wire bus down to the lower voltage progressively with incremental drive strengths. As a result, the master circuit can signal the start of the SOS sequence without causing bus ringing in the single-wire bus circuit.

### FIELD OF THE DISCLOSURE

The technology of the disclosure relates generally to changing a bus voltage in multiple steps in a single-wire bus circuit.

### BACKGROUND

Mobile communication devices have become increasingly common in current society. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

To provide the redefined user experience, a state-of-the-art wireless communication device (e.g., smartphone) is equipped with a variety of electrical circuits to support various applications and enable various user experiences. In addition, the wireless communication device also employs a variety of communication buses to enable inter-circuit and intra-circuit communications. As an example, a two-wire radio frequency front-end (RFFE) bus can enable a transceiver circuit(s) to communicate with a power amplifier circuit, a power management circuit, and/or an antenna circuit, a multi-wire, high-bandwidth memory bus can enable time-critical direct access to a memory circuit, and a multi-wire general purpose input/output (GPIO) bus can bridge communications to an external peripheral device.

However, not all communications require a multi-wire bus like the RFFE bus, the memory bus, and the GPIO bus. In some cases, a single-wire serial bus may be sufficient or even desired for carrying out low-speed and/or low-bandwidth communications between certain types of circuits (e.g., antenna tuner, sensor, and switch).

### SUMMARY

Aspects disclosed in the detailed description are related to progressive voltage change in a single-wire bus circuit. In the single-wire bus circuit, a master circuit is configured to communicate bus telegrams with multiple slave circuits over the single-wire bus. Each of the bus telegrams starts with a start-of-sequence (SOS) sequence. The master circuit is configured to signal a start of the SOS sequence by pulling the single-wire bus from a higher voltage to a lower voltage. In order to overcome a combined resistance of the single-wire bus and the multiple slave circuits, the master circuit must pull the single-wire bus down with a strong enough drive strength that may inadvertently cause bus ringing in the single-wire bus circuit. In embodiments disclosed herein, the master circuit is configured to pull the single-wire bus down to the lower voltage progressively with incremental drive strengths. As a result, the master circuit can signal the start of the SOS sequence without causing bus ringing in the single-wire bus circuit.

In one aspect, a single-wire bus circuit is provided. The single-wire bus circuit includes multiple slave circuits. Each of the multiple slave circuits is coupled to a single-wire bus consisting of one wire. Each of the multiple slave circuits is configured to draw a bus current over the single-wire bus during a fast-charge period wherein a bus voltage of the single-wire bus is held at a higher bus voltage level. Each of the multiple slave circuits is also configured to stop drawing the bus current in response to detecting that the bus voltage of the single-wire bus is pulled down to a lower bus voltage level. The single-wire bus circuit also includes a master circuit. The master circuit is coupled to the single-wire bus. The master circuit is configured to progressively increase drive strength during a transition period comprising multiple clock cycles to thereby pull the bus voltage of the single-wire bus from the higher bus voltage level down to the lower bus voltage level in one or more of the multiple clock cycles.

In another aspect, a method for enabling progressive voltage pulldown in a single-wire bus circuit is provided. The method includes drawing, by each of multiple slave circuits, a bus current over a single-wire bus consisting of one wire during a fast-charge period wherein a bus voltage of the single-wire bus is held at a higher bus voltage level. The method also includes stopping, by each of the multiple slave circuits, to draw the bus current in response to detecting that the bus voltage of the single-wire bus is pulled down to a lower bus voltage level. The method also includes progressively increasing drive strength, by a master circuit, during a transition period comprising multiple clock cycles to thereby pull the bus voltage of the single-wire bus from the higher bus voltage level down to the lower bus voltage level in one or more of the multiple clock cycles.

In another aspect, a wireless device is provided. The wireless device includes a single-wire bus circuit. The single-wire bus circuit includes multiple slave circuits. Each of the multiple slave circuits is coupled to a single-wire bus consisting of one wire. Each of the multiple slave circuits is configured to draw a bus current over the single-wire bus during a fast-charge period wherein a bus voltage of the single-wire bus is held at a higher bus voltage level. Each of the multiple slave circuits is also configured to stop drawing the bus current in response to detecting that the bus voltage of the single-wire bus is pulled down to a lower bus voltage level. The single-wire bus circuit also includes a master circuit. The master circuit is coupled to the single-wire bus. The master circuit is configured to progressively increase drive strength during a transition period comprising multiple clock cycles to thereby pull the bus voltage of the single-wire bus from the higher bus voltage level down to the lower bus voltage level in one or more of the multiple clock cycles.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure and, together with the description, serve to explain the principles of the disclosure.

FIG. 1A is a schematic diagram of an exemplary conventional single-wire bus apparatus in which a master circuit is configured to communicate with a slave circuit(s) over a single-wire bus;

FIG. 1B is a schematic diagram providing an exemplary illustration of one or more write telegrams communicated from the master circuit to the slave circuit(s) over the single-wire bus of FIG. 1A;

FIG. 1C is a schematic diagram providing an exemplary illustration of one or more bus read telegrams communicated from the slave circuit(s) to the master circuit over the single-wire bus of FIG. 1A;

FIG. 1D is a schematic diagram providing an exemplary illustration of a start-of-sequence (SOS) sequence preceding each of the write telegrams of FIG. 1B and the bus read telegrams of FIG. 1C;

FIG. 2 is a schematic diagram of an exemplary single-wire bus circuit wherein a master circuit and multiple slave circuits are connected to a single-wire bus and the master circuit is configured according to embodiments of the present disclosure to signal a bus status change based on a progressive voltage pulldown scheme;

FIG. 3 is a graphic diagram providing an exemplary illustration of the progressive voltage pulldown scheme;

FIG. 4 is a schematic diagram of an exemplary bus driver circuit that can be provided in the master circuit in FIG. 2 to enable the progressive voltage pulldown scheme of FIG. 3;

FIG. 5 is a graphic diagram of an exemplary slave control circuit that can be provided in each of the slave circuits in FIG. 2 and configured according to an embodiment of the present disclosure to reduce radio frequency (RF) noise resulting from the progressive voltage pulldown scheme of FIG. 3;

FIGS. 6A and 6B are graphic diagrams illustrating effectiveness of the slave control circuit of FIG. 5 in reducing the RF noise in the slave circuits in FIG. 2;

FIG. 7 is a schematic diagram of an exemplary communication device wherein the single-wire bus circuit of FIG. 2 can be provided; and

FIG. 8 is a flowchart of an exemplary process whereby the single-wire bus circuit of FIG. 2 can support the processive voltage pulldown scheme of FIG. 3.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description are related to progressive voltage change in a single-wire bus circuit. In the single-wire bus circuit, a master circuit is configured to communicate bus telegrams with multiple slave circuits over the single-wire bus. Each of the bus telegrams starts with a start-of-sequence (SOS) sequence. The master circuit is configured to signal a start of the SOS sequence by pulling the single-wire bus from a higher voltage to a lower voltage. In order to overcome a combined resistance of the single-wire bus and the multiple slave circuits, the master circuit must pull the single-wire bus down with a strong enough drive strength that may inadvertently cause bus ringing in the single-wire bus circuit. In embodiments disclosed herein, the master circuit is configured to pull the single-wire bus down to the lower voltage progressively with incremental drive strengths. As a result, the master circuit can signal the start of the SOS sequence without causing bus ringing in the single-wire bus circuit.

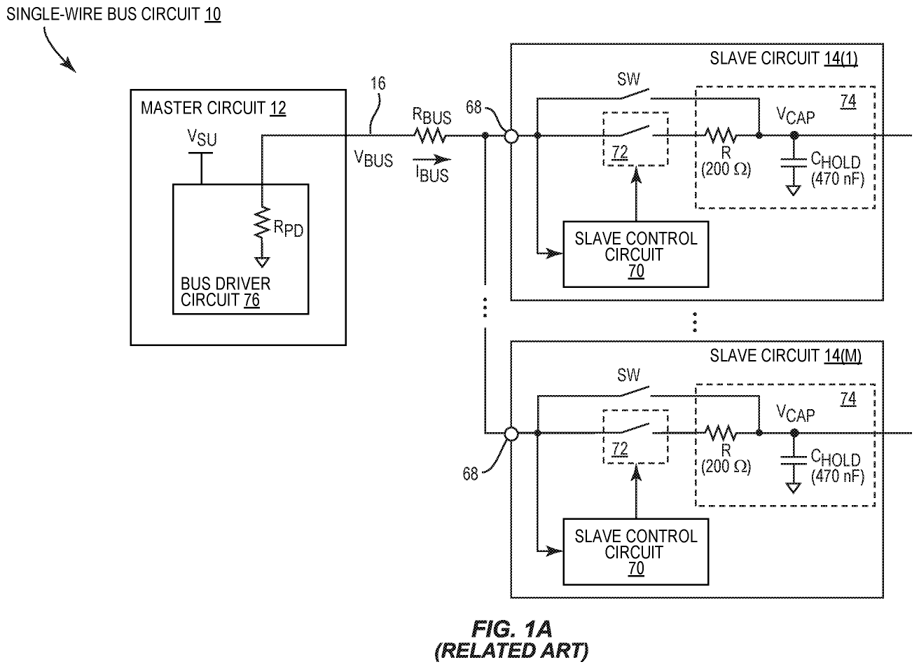

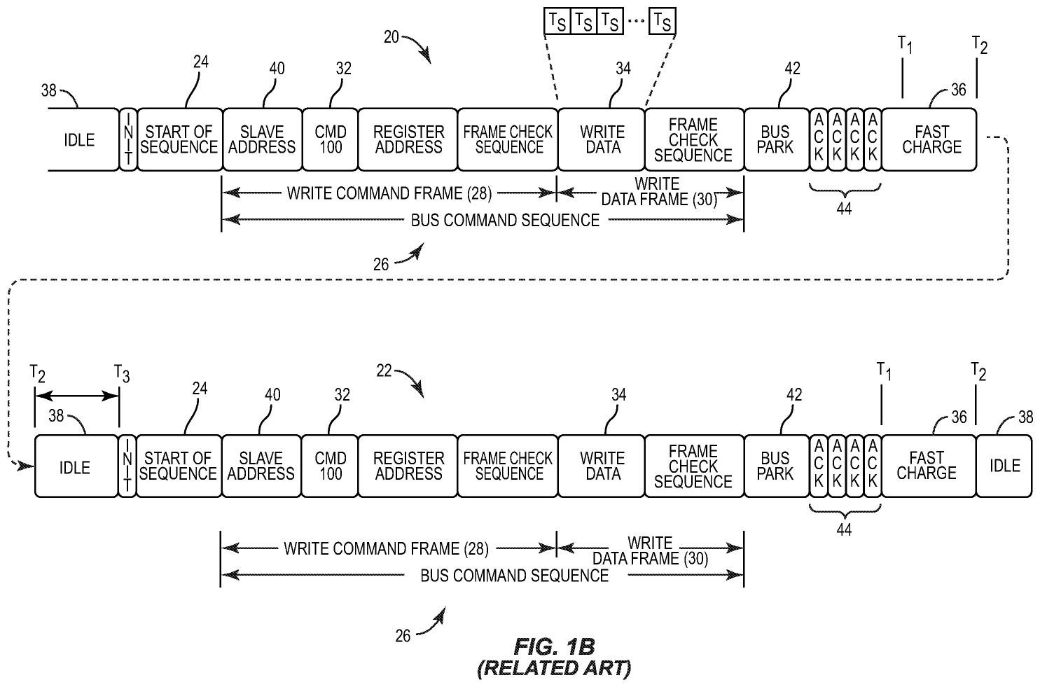

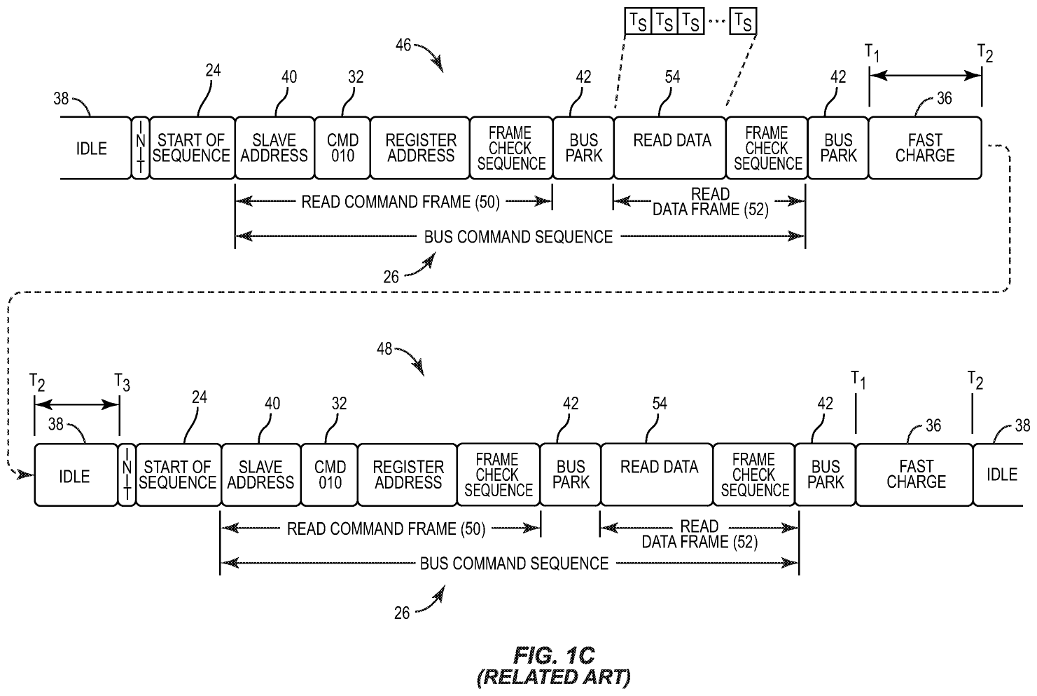

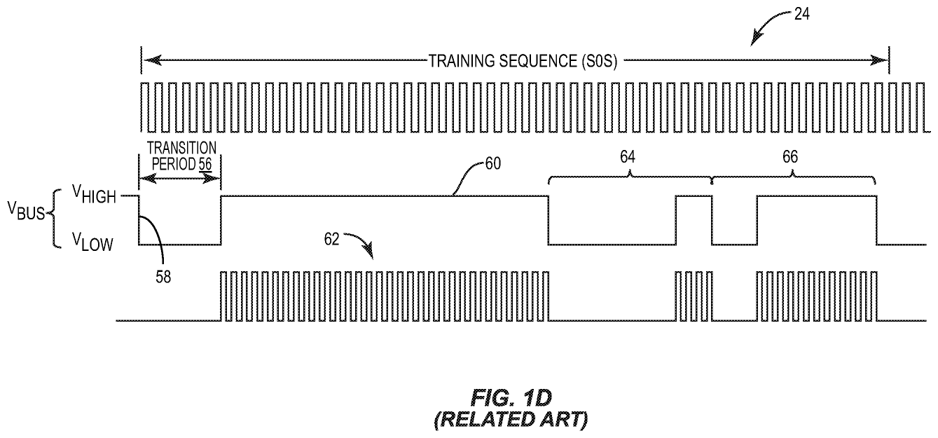

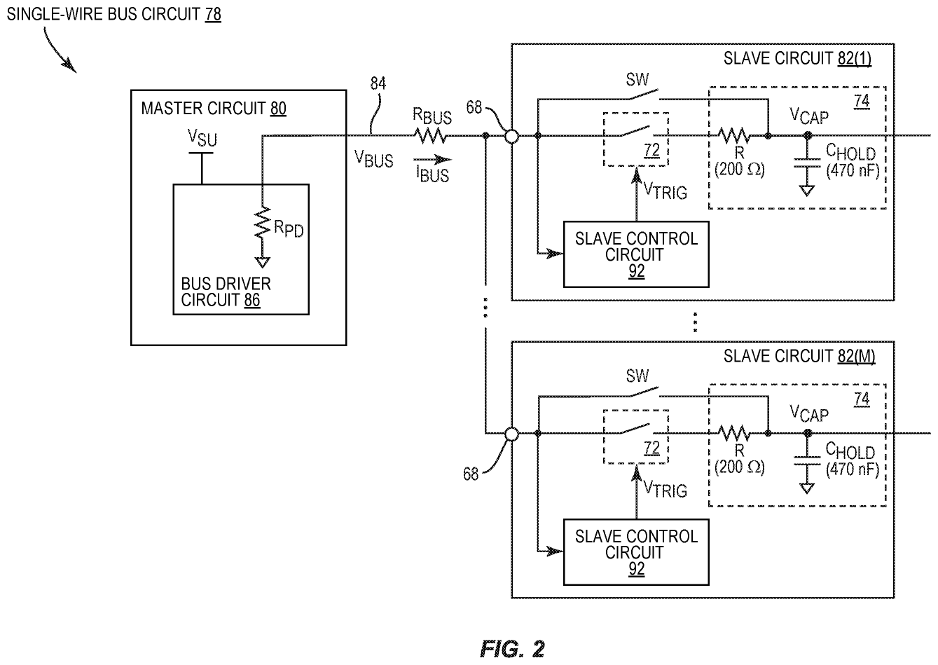

Before discussing a single-wire bus circuit of the present disclosure, starting at FIG. 2, a brief overview of a conventional single-wire bus circuit is first provided with reference to FIGS. 1A-1D to help understand basic operations of the single-wire bus and the technical problems to be solved herein.

FIG. 1A is a schematic diagram of an exemplary conventional single-wire bus circuit 10 wherein a master circuit 12 is configured to communicate with a number of slave circuits 14(1)-14(M) over a single-wire bus 16. Herein, the single-wire bus circuit 10 is configured according to a star typology (a.k.a. centralized typology) in which the master circuit 12 is configured to always initiate communications over the single-wire bus 16 by communicating a bus telegram(s) to the slave circuits 14(1)-14(M). The slave circuits 14(1)-14(M) may provide a data payload(s) to the master circuit 12 over the single-wire bus 16 in response to receiving the bus telegram(s) from the master circuit 12. Hereinafter, the bus telegram(s) communicated from the master circuit 12 to the slave circuits 14(1)-14(M) is referred to as “a forward bus telegram(s)” and the data payload(s) communicated from the slave circuits 14(1)-14(M) to the master circuit 12 are referred to as “a reverse bus telegram(s).”

FIG. 1B is a schematic diagram providing an exemplary illustration of one or more write telegrams 20, 22 communicated from the master circuit 12 to any of the slave circuits 14(1)-14(M) over the single-wire bus 16 of FIG. 1A. Each of the write telegrams 20, 22 begins with an SOS sequence 24, followed by a bus command sequence 26. The bus command sequence 26 includes a write command frame 28 and a write data frame 30. The write command frame 28 includes a command field 32 (denoted as “CMD”), which is encoded with a binary value “100” to indicate a register-write operation. The write data frame 30 includes a write data period 34. The write data period 34 can include one or more write data symbols Ts modulated to carry data to the slave circuits 14(1)-14(M) during the write operation. In this regard, the write telegrams 20, 22 may be an example of the forward bus telegram(s).

The SOS sequence 24 always precedes the bus command sequence 26 and is always communicated from the master circuit 12 to the slave circuits 14(1)-14(M). The write telegram 22, which succeeds the write telegram 20, may be separated from the write telegram 20 by a fast-charge period 36 that starts at time T₁ and ends at time T₂ (T₂>T₁) and an idle period 38 that starts at time T₂ and ends at time T₃ (T₃>T₂). Collectively, a duration between time T₁ and T₃ is also referred to as a suspension period (T₃-T₁).

The fast-charge period 36 is configured to allow each of the slave circuits 14(1)-14(M) to draw a higher charging current via the single-wire bus 16 and harvest power from the higher charging current. In this regard, the single-wire bus 16 is said to be in a fast-charge state during the fast-charge period 36.

The idle period 38 may be a no-activity period in which the master circuit 12 and the slave circuits 14(1)-14(M) may be inactive to help conserve power. Accordingly, the single-wire bus 16 is said to be in an idle state during the idle period 38.

The bus command sequence also includes a slave address field 40, a bus park period 42, and four acknowledgement (ACK) symbols 44. The slave address field 40 can be used to address the slave circuits 14(1)-14(M). The bus park period 42 may be used to switch between the forward and the reverse communication modes. The ACK symbols 44 can be used by up to four of the slave circuits 14(1)-14(M) to acknowledge a respective receipt of the data carried in the write data period 34. Given that the ACK symbols 44 are communicated immediately before the fast-charge period 36, each of the slave circuits 14(1)-14(M) can determine the time T₁ to start the fast-charge period 36 by counting four ACKs communicated in the four ACK symbols 44 from the end of the bus park period 42.

Each of the slave circuits 14(1)-14(M) is uniquely identified by a respective unique slave identification (USID). As such, the bus command sequence 26 in the write telegrams 20, 22 can be a unicast command sequence destined to any one of the slave circuits 14(1)-14(M) when the slave address field 40 contains the USID of the any one of the slave circuits 14(1)-14(M). The bus command sequence 26 in the write telegrams 20, 22 can also be a multicast command sequence destined to a subset of the slave circuits 14(1)-14(M) when the slave address field 40 contains a group slave identification (GSID) corresponding to the subset of the slave circuits 14(1)-14(M). Furthermore, the bus command sequence 26 in the write telegrams 20, 22 can be a broadcast command sequence destined to all of the slave circuits 14(1)-14(M) when the slave address field 40 contains a broadcast slave identification (BSID).

FIG. 1C is a schematic diagram providing an exemplary illustration of one or more read telegrams 46, 48 communicated from the slave circuits 14(1)-14(M) to the master circuit 12 over the single-wire bus 16 of FIG. 1A. Common elements between FIGS. 1B and 1C are shown therein with common element numbers and will not be re-described herein.

Each of the read telegrams 46, 48 includes the bus command sequence 26. The bus command sequence 26 includes a read command frame 50 and a read data frame 52, separated by a bus park period 42. The read command frame 50 includes the command field 32 (denoted as “CMD”), which is encoded with a binary value “010” to indicate a read operation. The read data frame 52 includes a read data period 54, which includes one or more read data symbols Ts modulated to carry data payloads to the master circuit 12 during the register-read operation. The master circuit 12 first communicates the read command frame 50 to the slave circuits 14(1)-14(M) identified by the slave address field 40 to initiate the register-read operation. The master circuit 12 then tri-states during the bus park period 42 to yield control of the single-wire bus 16 to the slave circuits 14(1)-14(M). Subsequently, the slave circuits 14(1)-14(M) can begin sending the data payloads in the read data period 54. In this regard, the read telegrams 46, 48 may be an example of both the forward and the reverse bus telegram(s).

With reference back to FIG. 1A, the master circuit 12 is configured to suspend the bus telegram communication over the single-wire bus 16 during the suspension period (T₃-T₁). Accordingly, the master circuit 12 and the slave circuits 14(1)-14(M) are configured to refrain from communicating the bus telegram(s) and data payload(s) from time T₁ to T₃. In this regard, the single-wire bus 16 can be said to be in suspension mode between time T₁ and T₃. During the suspension period (T₃-T₁), the master circuit 12 maintains a bus voltage V_{BUS} of the single-wire bus 16 at a higher voltage level V_{HIGH} (V_{HIGH}>0 V). As such, the slave circuits 14(1)-14(M) can each draw a charging current over the single-wire bus 16 to thereby harvest power from the master circuit 12.

The master circuit 12 is further configured to signal a transition from the suspension period (T₃-T₁) to the SOS sequence 24 by pulling the bus voltage V_{BUS} from the higher voltage level V_{HIGH} to a lower voltage level V_{LOW}. FIG. 1D is a schematic diagram providing an exemplary illustration of the SOS sequence 24 in FIGS. 1B and 1C. Common elements between FIGS. 1B, 1C, and 1D are shown therein with common element numbers and will not be re-described herein.

The SOS sequence 24 is a unique sequence that can never occur with any bit combination in the bus command sequence 26. Each of the slave circuits 14(1)-14(M) is configured to always watch for the SOS sequence 24, which signals a start of the write telegrams 20, 22 and the read telegrams 46, 48.

To signal the transition from the suspension period (T₃-T₁) to the SOS sequence 24, the master circuit 12 is configured to pull the bus voltage V_{BUS} from the higher voltage level V_{HIGH} down to the lower voltage level V_{LOW} during a transition period 56 such that each of the slave circuits 14(1)-14(M) can detect a falling edge 58 of the bus voltage V_{BUS} and, accordingly, stop harvesting power from the master circuit 12. The master circuit 12, on the other hand, is configured to keep the bus voltage V_{BUS} at the low voltage level V_{LOW} for an entire duration (e.g., ½ Ts) of the transition period 56 and revert the bus voltage V_{BUS} to the higher voltage level V_{HIGH} at the end of the transition period 56.

The SOS sequence 24 includes a synchronization interval 60, during which the master circuit 12 maintains the bus voltage V_{BUS} at the higher voltage level V_{HIGH}. The synchronization interval 60 includes a number of digitally controlled oscillator (DCO) pulses 62 whereby each of the slave circuits 14(1)-14(M) can establish a respective timing basis (e.g., for read, acknowledgement, and other functions). Following the synchronization interval 60, there is a pair of pulse-width modulation (PWM) symbols 64, 66. In a non-limiting example, the PWM symbol 64 is modulated to represent a binary “0” and the PWM symbol 66 is modulated to represent a binary “1.”

With reference back to FIG. 1A, each of the slave circuits 14(1)-14(M) can be configured to include an input node 68, a slave control circuit 70, a power switch 72, a fast-charging switch SW, and a power harvesting circuit 74. Specifically, the input node 68 is coupled to the single-wire bus 16, the power switch 72 is coupled to the input node 68, and the power harvesting circuit 74 is coupled to the power switch 72. The power harvesting circuit 74 may be implemented as a resistor-capacitor (RC) circuit that includes a resistor R (e.g., 200Ω and a holding capacitor C_{HOLD} (e.g., 470 nF).

The slave control circuit 70 is configured to close the fast-charging switch SW during the fast charge period 36 to couple the power harvesting circuit 74 to the input node 68. As such, each of the slave circuits 14(1)-14(M) can draw a bus current I_{BUS} directly from the input node 68 to charge the holding capacitor C_{HOLD} to a local voltage V_{CAP}. In contrast, during the idle period 38, the slave control circuit 70 opens the fast-charging switch SW and closes the power switch 72. When the slave control circuit 70 detects the falling edge 58 of the bus voltage V_{BUS} during the transition period 56, the slave control circuit 70 opens the power switch 72 to decouple the power harvesting circuit 74 from the input node 68. As a result, the holding capacitor C_{HOLD} will be discharged to power certain operations of the slave circuits 14(1)-14(M), such as demodulating the write telegrams 20, 22 and modulating the read telegrams 46, 48.

The master circuit 12 includes a bus driver circuit 76 that is configured to drive the bus voltage V_{BUS} between the higher voltage level V_{HIGH} and the lower voltage level V_{LOW} based on a supply voltage V_{SU} (e.g., a battery voltage). Specifically, to allow each of the slave circuits 14(1)-14(M) to effectively detect the falling edge 58 of the bus voltage V_{BUS} during the transition period 56, the bus driver circuit 76 needs to drive the lower voltage level V_{LOW}, as seen by the slave control circuit 70 at the input node 68, below three-tenths of the local voltage V_{CAP} (V_{LOW}≤0.3*V_{CAP}).

Understandably, the bus driver circuit 76 can have an inherent pulldown resistance RPD and the single-wire bus 16 can have an inherent bus resistance R_{BUS}. In this regard, when bus driver circuit 76 pulls the bus voltage V_{BUS} to a ground, the pulldown resistance RPD, the bus resistance R_{BUS}, and the resistor R in each of the slave circuits 14(1)-14(M) will form a voltage divider to divide the local voltage V_{CAP} at the input node 68. Accordingly, the lower voltage level V_{LOW}, as detected at the input node 68, can be expressed by equation (Eq. 1) below.

$${V}_{LOW} = {V}_{CAP} \times ( {R}_{P D} + {R}_{BUS} ) / ( {R}_{P D} + {R}_{BUS} + R / M ) \qquad ( Eq . 1 )$$

In the equation (Eq. 1), M represents a total number of the slave circuits 14(1)-14(M). It is obvious from equation (Eq. 1) that, when the bus resistance R_{BUS} and the resistance R in each of the slave circuits 14(1)-14(M) are held constant, the lower voltage level V_{LOW} at the input node 68 will be driven closer to the local voltage V_{CAP} when the total number (M) of the slave circuits 14(1)-14(M) increases. As a result, the bus driver circuit 76 must apply more drive strength to overcome the impact of the increased number of the slave circuits 14(1)-14(M). As can be seen from equation (Eq. 1), the bus driver circuit 76 may increase the drive strength by reducing the pulldown resistance RPD. In this regard, it can be said that the drive strength is inversely related to the pulldown resistance RPD.

However, if the bus driver circuit 76 applies too much drive strength to overcome the impact of the increased number of the slave circuits 14(1)-14(M), particularly when the single-wire bus 16 is routed over a large bus radius, the single-wire bus circuit 10 may end up experiencing a bus ringing that can cause radiated noise, conducted noise, and/or incorrect logic level detection in the single-wire bus circuit 10. In the context of the present disclosure, the bus ringing can result when a rise and fall time (TR-F) of the bus voltage V_{BUS} meets the condition expressed in equation (Eq. 2).

$${T}_{R - F} \leq 2 \times [ Path Length in Meter / ( \sqrt{{ε}_{γ}} \times 300 \times {10}^{6} ) ] \qquad ( Eq . 2 )$$

In the equation (Eq. 2), Ey is approximately equal to four (4) for typical printed circuit board (PCB) materials. As such, the technical problem to be solved herein is to drive the lower voltage level V_{LOW} to below 0.3*V_{CAP} within the transition period 56 without causing bus ringing in the single-wire bus circuit 10.

In this regard, FIG. 2 is a schematic diagram of an exemplary single-wire bus circuit 78 wherein a master circuit 80 and multiple slave circuits 82(1)-82(M) are connected to a single-wire bus 84. Herein, the single-wire bus circuit 78 is configured to reuse as many circuitries as possible from the single-wire bus circuit 10 of FIG. 1A to help reduce bill-of-material (BOM) cost. As such, common elements between FIGS. 1A and 2 are shown therein with common element numbers and will not be re-described herein.

The master circuit 80 includes a bus driver circuit 86. The bus driver circuit 86 is configured according to an embodiment of the present disclosure to pull a bus voltage V_{BUS} from a higher voltage level V_{HIGH} down to a lower voltage level V_{LOW} during the transition period 56 in FIG. 1D based on a progressive voltage pulldown scheme. With the progressive pulldown scheme, the bus driver circuit 86 is configured to incrementally increase drive strength to pull the bus voltage V_{BUS} from the higher voltage level V_{HIGH} down to the lower voltage level V_{LOW} during the transition period 56. By incrementally increasing the drive strength, it is possible to prevent the bus voltage V_{BUS} from rising and/or falling too quickly to cause the bus ringing situation.

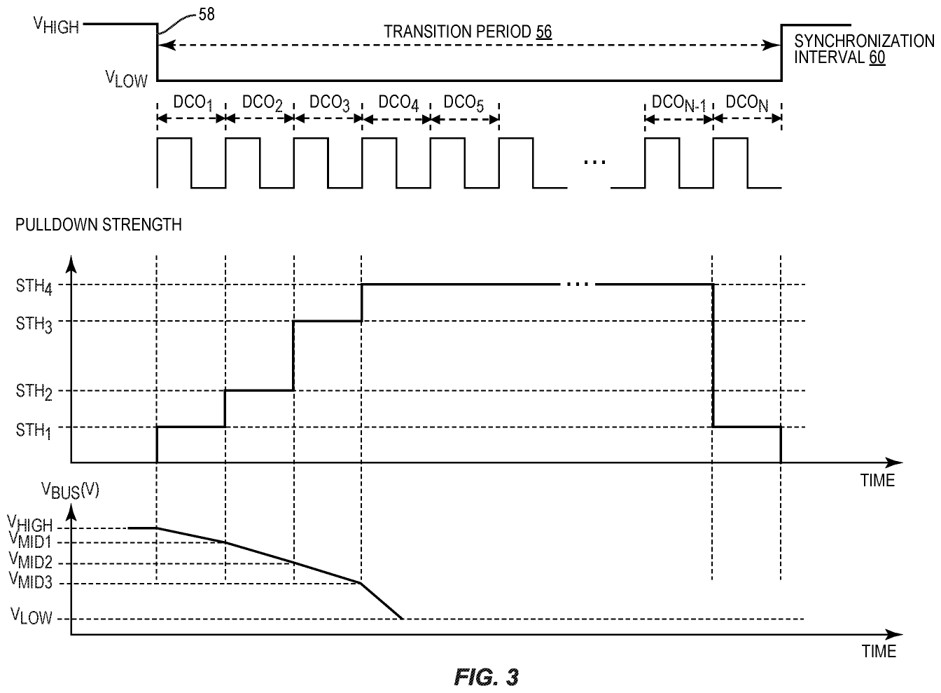

FIG. 3 is a graphic diagram providing a detailed illustration of the progressive voltage pulldown scheme employed by the single-wire bus circuit 78 of FIG. 2. Common elements between FIGS. 1D, 2, and 3 are shown therein with common element numbers and will not be re-described herein.

Herein, the transition period 56 includes multiple clock cycles DCO₁-DCO_{N} and the bus driver circuit 86 is configured to incrementally increase the drive strength over a number of consecutive ones of the clock cycles DCO₁-DCO_{N}. In an embodiment, the bus driver circuit 86 applies a first drive strength STH₁ during a first one (DCO₁) of the clock cycles DCO₁-DCO_{N} to thereby pull the bus voltage V_{BUS} from the higher bus voltage level V_{HIGH} down to a first intermediate bus voltage level V_{MID1} (V_{MID1}<V_{HIGH}). In a non-limiting example, the first drive strength STH₁ can be a predefined default drive strength predetermined based on such factors as a total number of the slave circuits 82(1)-82(M), a bus radius of the single-wire bus circuit 78, and so on.

During the second one (DCO₂) of the clock cycles DCO₁-DCO_{N}, the bus driver circuit 86 applies a second drive strength STH₂ (STH₂>STH₁) to further pull the bus voltage V_{BUS} from the first intermediate bus voltage level V_{MID1} to a second intermediate bus voltage level V_{MID2} (V_{MID2}<V_{MID1}). In an embodiment, the second drive strength STH₂ is equal to twice the first drive strength STH₁ (STH₂=2×STH₁).

During the third one (DCO₃) of the clock cycles DCO₁-DCO_{N}, the bus driver circuit 86 applies a third drive strength STH₃ (STH₃>STH₂) to further pull the bus voltage V_{BUS} from the second intermediate bus voltage level V_{MID2} to a third intermediate bus voltage level V_{MID3} (V_{MID3}<V_{MID2}). In an embodiment, the third drive strength STH₃ can be a predefined maximum drive strength that is predetermined for the single-wire bus circuit 78 based on specific configuration and operating conditions.

During the fourth one (DCO₄) of the clock cycles DCO₁-DCO_{N}, the bus driver circuit 86 applies a fourth drive strength STH₄ (STH₄>STH₃) to further pull the bus voltage V_{BUS} from the third intermediate bus voltage level V_{MID3} to the lower voltage level V_{LOW} (V_{LOW}<V_{MID3}). In an embodiment, the fourth drive strength STH₃ is equal to a sum of the first drive strength STH₁ and the third drive strength STH₃ (STH₄=STH₁+STH₃).

Subsequently, the bus driver circuit 86 maintains the fourth drive strength STH₄ from the fifth one (DCO₅) of the of clock cycles DCO₁-DCO_{N} through a second-to-last one (DCO_{N-1}) of the clock cycles DCO₁-DCO_{N} and reverts to the first drive strength STH₁ in a last one (DCO_{N}) of the clock cycles DCO₁-DCO_{N}. In an embodiment, the transition period 56 can be configured to include six clock cycles DCO₁-DCO₆. In this regard, the bus driver circuit 86 will maintain the fourth drive strength STH₄ during the clock cycle DCO₅ and revert to the first drive strength STH₁ in the clock cycle DCO₆. In another embodiment, the transition period 56 can be configured to include seven clock cycles DCO₁-DCO₇. In this regard, the bus driver circuit 86 will maintain the fourth drive strength STH₄ during the clock cycles DCO₅ and DCO₆, and subsequently revert to the first drive strength STH₁ in the clock cycle DCO₇.

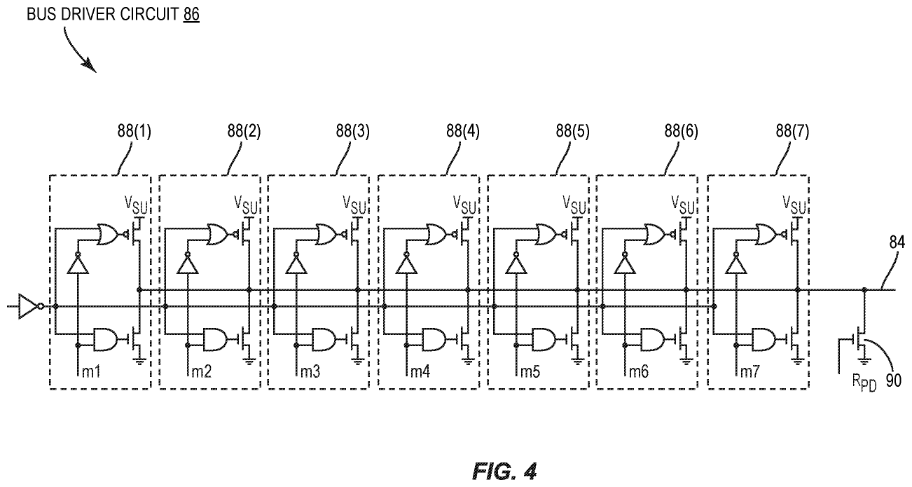

With reference back to FIG. 2, the bus driver circuit 86 can be a programmable segmented driver, as illustrated in FIG. 4. FIG. 4 is a schematic diagram providing an exemplary illustration of the bus driver circuit 86 in FIG. 2. Common elements between FIGS. 2 and 4 are shown therein with common element numbers and will not be re-described herein.

Herein, the bus driver circuit 86 includes multiple driver segments 88(1)-88(7), each of which corresponds to a respective one of multiple multipliers m1-m7. In a non-limiting example, the multipliers m1-m7 can be 0.2, 0.2, 0.4, 1, 2, 2, and 2, respectively. In an embodiment, the multipliers m1-m7 can be set based on a lookup table (LUT) to provide different levels of drive strengths, such as the first drive strength STH₁, the second drive strength STH₂, the third drive strength STH₃, and the fourth drive strength STH₄ in FIG. 3. The bus driver circuit 86 further includes a transistor 90, which can be a metal-oxide semiconductor field-effect transistor (MOSFET), as an example. In an embodiment, the transistor 90 may be controlled to adjust the pulldown resistance RPD.

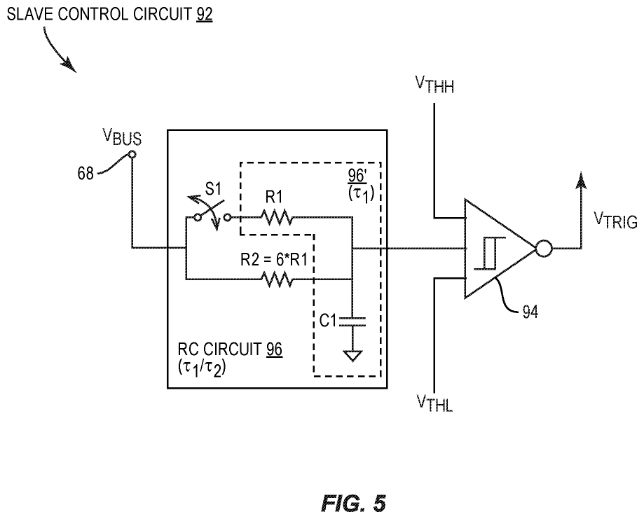

With reference back to FIG. 2, each of the slave circuits 82(1)-82(M) also includes a slave control circuit 92, which is enhanced from the slave control circuit 70 in FIG. 1 to help filter out radio frequency (RF) noises that may be created at the falling edge 58 by the progressive voltage pulldown scheme described in FIG. 3. FIG. 5 is a graphic diagram providing an exemplary illustration of the slave control circuit 92 in FIG. 2. Common elements between FIGS. 2 and 5 are shown therein with common element numbers and will not be re-described herein.

In an embodiment, the slave control circuit 70 in FIG. 1A and the slave control circuit 92 are both configured to function as a well-known Schmitt trigger, which typically includes a comparator 94 and a resistor-capacitor (RC) circuit 96. The RC circuit 96 is configured to apply a filter on the bus voltage V_{BUS} as seen at the input node 68. The comparator 94 is configured to operate based on a lower threshold voltage V_{THL} and a higher threshold voltage V_{THH} to thereby generate a trigger voltage V_{TRG} that indicates the rising and falling edges of the bus voltage V_{BUS}, such as the falling edge 58.

When configured as a conventional Schmitt trigger, the slave control circuit 92 would include a portion of the RC circuit 96 (referred to as a conventional RC circuit 96′ for distinction). The conventional RC circuit 96′ only includes a first resistor R1 and a capacitor C1 and has a first RC constant 11 (T₁=R1×C1). Studies have shown that the progressive voltage pulldown scheme can cause the bus voltage V_{BUS} to exceed the hysteresis of the conventional Schmitt trigger, thus making it difficult for the conventional RC circuit 96′ to filter out the RF noise that largely appears at the falling edge 58.

In this regard, in an embodiment, the RC circuit 96 is further configured to include a second resistor R2 and a switch S1. The switch S1 is coupled in series with the first resistor R1 between the input node 68 and the comparator 94. The second resistor R2 is coupled between the input node 68 and the comparator 94, in parallel to the switch S1 and the first resistor R1. In a non-limiting example, the second resistor R2 has six times the resistance of the first resistor R1 (R2=6×R1).

According to an embodiment, the switch S1 is opened during the transition period 56. As a result, the RC circuit 96 will have a second RC constant 12 (T₂=R2×C1) that is higher than the first RC constant T₁. As a result, the RC circuit 96 can effectively filter out the RF noise at the falling edge 58. Outside the transition period 56, the single-wire bus circuit 78 no longer operates in the progressive voltage pulldown scheme and, accordingly, the switch S1 can be closed.

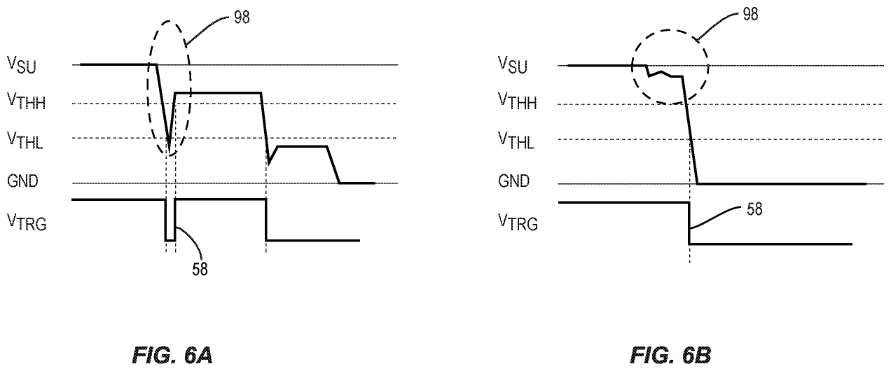

FIGS. 6A and 6B are graphic diagrams illustrating the effectiveness of the slave control circuit 92 of FIG. 5 in reducing the RF noise at the falling edge 58 of the bus voltage V_{BUS}. FIG. 6A shows that the conventional RC circuit 96′ is incapable of filtering out the RF noise 98 at the falling edge 58 of the bus voltage V_{BUS}. As a result, the trigger voltage V_{TRG} may provide an erroneous indication of the falling edge 58 of the bus voltage V_{BUS}. FIG. 6B shows that, by opening the switch S1, the RC circuit 96 can effectively filter out the RF noise 98 at the falling edge 58 of the bus voltage V_{BUS}. As a result, the trigger voltage V_{TRG} can provide a conclusive indication of the falling edge 58 of the bus voltage V_{BUS}.

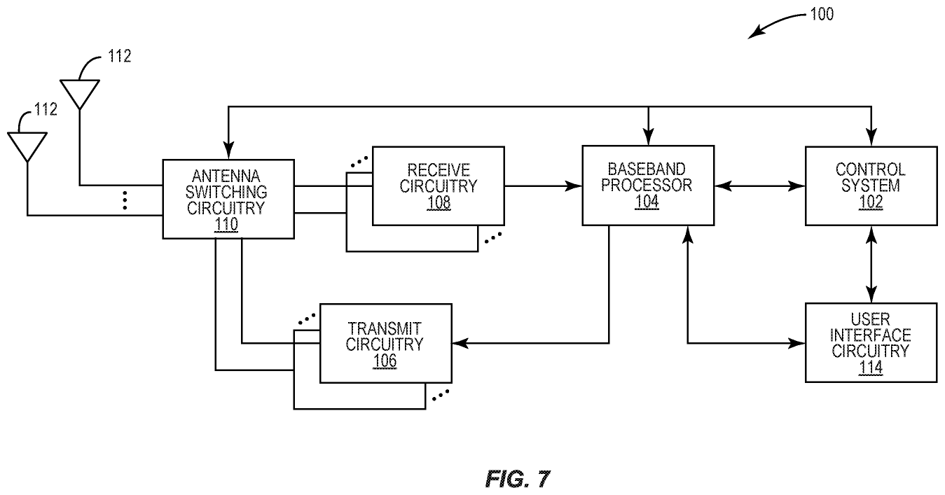

The single-wire bus circuit 78 of FIG. 2 can be provided in a communication device to support the embodiments described above. In this regard, FIG. 7 is a schematic diagram of an exemplary communication device 100 wherein the single-wire bus circuit 78 of FIG. 2 can be provided.

Herein, the communication device 100 can be any type of communication device, such as mobile terminal, smart watch, tablet, computer, navigation device, access point, base station (e.g., eNB, gNB, etc.), and any other wireless communication device that supports wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

In an embodiment, the master circuit 80 may be provided in the baseband processor 104, the transmit circuitry 106, and/or the receive circuitry 108. The slave circuits 82(1)-82(M), on the other hand, may be provided in the antenna switching circuitry 110 and the antennas 112.

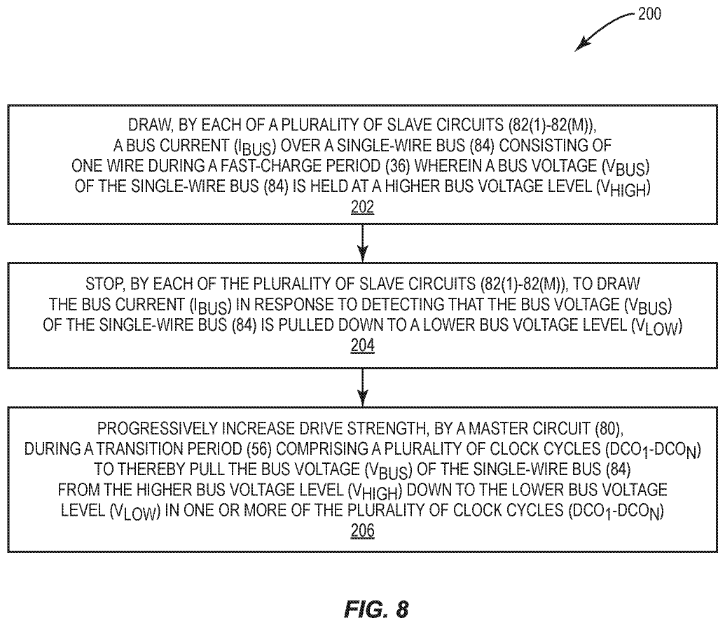

In an embodiment, the single-wire bus circuit 78 of FIG. 2 can be configured to progressively pull down the bus voltage V_{BUS} according to a process. FIG. 8 is a flowchart of an exemplary process 200 whereby the single-wire bus circuit 78 of FIG. 2 can support the progressive voltage pulldown scheme of FIG. 3.

Herein, the process 200 includes drawing, by each of the slave circuits 82(1)-82(M), the bus current I_{BUS} over the single-wire bus 84 consisting of one wire during the fast-charge period 36 wherein the bus voltage V_{BUS} of the single-wire bus 84 is held at the higher bus voltage level V_{HIGH} (step 202). The process 200 also includes stopping, by each of the slave circuits 82(1)-82(M), to draw the bus current I_{BUS} in response to detecting that the bus voltage V_{BUS} of the single-wire bus 84 is pulled down to a lower bus voltage level V_{LOW} (step 204). The process 200 also includes progressively increasing drive strength, by the master circuit 80, during the transition period 56 comprising the clock cycles DCO₁-DCO_{N} to thereby pull the bus voltage V_{BUS} of the single-wire bus 84 from the higher bus voltage level V_{HIGH} down to the lower bus voltage level V_{LOW} in one or more of the clock cycles DCO₁-DCO_{N} (step 206).

Those skilled in the art will recognize improvements and modifications to the embodiments of the present disclosure. All such improvements and modifications are considered within the scope of the concepts disclosed herein and the claims that follow.

What is claimed is:

1. A single-wire bus circuit comprising:
a plurality of slave circuits each coupled to a single-wire bus consisting of one wire and configured to:
draw a bus current over the single-wire bus during a fast-charge period wherein a bus voltage of the single-wire bus is held at a higher bus voltage level; and
stop drawing the bus current in response to detecting that the bus voltage of the single-wire bus is pulled down to a lower bus voltage level; and
a master circuit coupled to the single-wire bus and configured to progressively increase drive strength during a transition period comprising a plurality of clock cycles to thereby pull the bus voltage of the single-wire bus from the higher bus voltage level down to the lower bus voltage level in one or more of the plurality of clock cycles.

2. The single-wire bus circuit of claim 1, wherein the master circuit is further configured to:
apply a first drive strength during a first one of the plurality of clock cycles to thereby pull the bus voltage of the single-wire bus from the higher bus voltage level down to a first intermediate bus voltage level;
apply a second drive strength higher than the first drive strength during a second one of the plurality of clock cycles immediately succeeding the first one of the plurality of clock cycles to thereby further pull the bus voltage of the single-wire bus from the first intermediate bus voltage level to a second intermediate bus voltage level;
apply a third drive strength higher than the second drive strength during a third one of the plurality of clock cycles immediately succeeding the second one of the plurality of clock cycles to thereby further pull the bus voltage of the single-wire bus from the second intermediate bus voltage level to a third intermediate bus voltage level; and
apply a fourth drive strength higher than the third drive strength during a fourth one of the plurality of clock cycles immediately succeeding the third one of the plurality of clock cycles to thereby further pull the bus voltage of the single-wire bus from the third intermediate bus voltage level to the lower bus voltage level.

3. The single-wire bus circuit of claim 2, wherein the master circuit is further configured to:
maintain the fourth drive strength applied in the fourth one of the plurality of clock cycles through a second-to-last one of the plurality of clock cycles; and
revert to the first drive strength in a last one of the plurality of clock cycles.

4. The single-wire bus circuit of claim 2, wherein:
the first drive strength is equal to a predefined default drive strength;
the second drive strength is equal to twice the first drive strength;
the third drive strength is equal to a predefined maximum drive strength higher than the second drive strength; and
the fourth drive strength is equal to a sum of the first drive strength and the third drive strength.

5. The single-wire bus circuit of claim 1, wherein the master circuit is further configured to progressively increase the drive strength by progressively reducing a pulldown resistance of the master circuit.

6. The single-wire bus circuit of claim 1, wherein each of the plurality of slave circuits comprises:
a power harvesting circuit coupled to the single-wire bus via a power switch; and
a slave control circuit configured to:
close the power switch during the fast-charge period such that the power harvesting circuit can draw the bus current over the single-wire bus to thereby harvest power; and
open the power switch in response to detecting that the single-wire bus is pulled down to the lower bus voltage level.

7. The single-wire bus circuit of claim 6, wherein the slave control circuit comprises:
a resistor-capacitor (RC) circuit configured to:
filter the bus voltage of the single-wire bus based on a longer RC constant during the transition period; and
filter the bus voltage of the single-wire bus based on a shorter RC constant outside the transition period; and
a comparator configured to:
determine whether the bus voltage of the single-wire bus is pulled down to the lower bus voltage level based on a pair of threshold voltages; and
generate a trigger voltage to open the power switch in response to determining that the bus voltage of the single-wire bus is pulled down to the lower bus voltage level.

8. The single-wire bus circuit of claim 7, wherein the RC circuit comprises:
a capacitor coupled to a ground;
a switch and a first resistor coupled in series between the single-wire bus and the capacitor; and
a second resistor coupled between the single-wire bus and the capacitor and having a larger resistance than the first resistor;
wherein the switch is opened during the transition period and opened outside the transition period.

9. A method for enabling progressive voltage pulldown in a single-wire bus circuit comprising:
drawing, by each of a plurality of slave circuits, a bus current over a single-wire bus consisting of one wire during a fast-charge period wherein a bus voltage of the single-wire bus is held at a higher bus voltage level;
stopping, by each of the plurality of slave circuits, to draw the bus current in response to detecting that the bus voltage of the single-wire bus is pulled down to a lower bus voltage level; and
progressively increasing drive strength, by a master circuit, during a transition period comprising a plurality of clock cycles to thereby pull the bus voltage of the single-wire bus from the higher bus voltage level down to the lower bus voltage level in one or more of the plurality of clock cycles.

10. The method of claim 9, further comprising:
applying a first drive strength during a first one of the plurality of clock cycles to thereby pull the bus voltage of the single-wire bus from the higher bus voltage level down to a first intermediate bus voltage level;
applying a second drive strength higher than the first drive strength during a second one of the plurality of clock cycles immediately succeeding the first one of the plurality of clock cycles to thereby further pull the bus voltage of the single-wire bus from the first intermediate bus voltage level to a second intermediate bus voltage level;
applying a third drive strength higher than the second drive strength during a third one of the plurality of clock cycles immediately succeeding the second one of the plurality of clock cycles to thereby further pull the bus voltage of the single-wire bus from the second intermediate bus voltage level to a third intermediate bus voltage level; and
applying a fourth drive strength higher than the third drive strength during a fourth one of the plurality of clock cycles immediately succeeding the third one of the plurality of clock cycles to thereby further pull the bus voltage of the single-wire bus from the third intermediate bus voltage level to the lower bus voltage level.

11. The method of claim 10, further comprising:
maintaining the fourth drive strength applied in the fourth one of the plurality of clock cycles through a second-to-last one of the plurality of clock cycles; and
reverting to the first drive strength in a last one of the plurality of clock cycles.

12. The method of claim 10, wherein:
the first drive strength is equal to a predefined default drive strength;
the second drive strength is equal to twice the first drive strength;
the third drive strength is equal to a predefined maximum drive strength higher than the second drive strength; and
the fourth drive strength is equal to a sum of the first drive strength and the third drive strength.

13. A wireless device comprising a single-wire bus circuit, the single-wire bus circuit comprises:
a plurality of slave circuits each coupled to a single-wire bus consisting of one wire and configured to:
draw a bus current over the single-wire bus during a fast-charge period wherein a bus voltage of the single-wire bus is held at a higher bus voltage level; and
stop drawing the bus current in response to detecting that the bus voltage of the single-wire bus is pulled down to a lower bus voltage level; and
a master circuit coupled to the single-wire bus and configured to progressively increase drive strength during a transition period comprising a plurality of clock cycles to thereby pull the bus voltage of the single-wire bus from the higher bus voltage level down to the lower bus voltage level in one or more of the plurality of clock cycles.

14. The wireless device of claim 13, wherein the master circuit is further configured to:
apply a first drive strength during a first one of the plurality of clock cycles to thereby pull the bus voltage of the single-wire bus from the higher bus voltage level down to a first intermediate bus voltage level;
apply a second drive strength higher than the first drive strength during a second one of the plurality of clock cycles immediately succeeding the first one of the plurality of clock cycles to thereby further pull the bus voltage of the single-wire bus from the first intermediate bus voltage level to a second intermediate bus voltage level;
apply a third drive strength higher than the second drive strength during a third one of the plurality of clock cycles immediately succeeding the second one of the plurality of clock cycles to thereby further pull the bus voltage of the single-wire bus from the second intermediate bus voltage level to a third intermediate bus voltage level; and
apply a fourth drive strength higher than the third drive strength during a fourth one of the plurality of clock cycles immediately succeeding the third one of the plurality of clock cycles to thereby further pull the bus voltage of the single-wire bus from the third intermediate bus voltage level to the lower bus voltage level.

15. The wireless device of claim 14, wherein the master circuit is further configured to:
maintain the fourth drive strength applied in the fourth one of the plurality of clock cycles through a second-to-last one of the plurality of clock cycles; and
revert to the first drive strength in a last one of the plurality of clock cycles.

16. The wireless device of claim 15, wherein:
the first drive strength is equal to a predefined default drive strength;
the second drive strength is equal to twice the first drive strength;
the third drive strength is equal to a predefined maximum drive strength higher than the second drive strength; and
the fourth drive strength is equal to a sum of the first drive strength and the third drive strength.

17. The wireless device of claim 13, wherein the master circuit is further configured to progressively increase the drive strength by progressively reducing a pulldown resistance of the master circuit.

18. The wireless device of claim 13, wherein each of the plurality of slave circuits comprises:
a power harvesting circuit coupled to the single-wire bus via a power switch; and
a slave control circuit configured to:
close the power switch during the fast-charge period such that the power harvesting circuit can draw the bus current over the single-wire bus to thereby harvest power; and
open the power switch in response to detecting that the single-wire bus is pulled down to the lower bus voltage level.

19. The wireless device of claim 18, wherein the slave control circuit comprises:
a resistor-capacitor (RC) circuit configured to:
filter the bus voltage of the single-wire bus based on a longer RC constant during the transition period; and
filter the bus voltage of the single-wire bus based on a shorter RC constant outside the transition period; and
a comparator configured to:
determine whether the bus voltage of the single-wire bus is pulled down to the lower bus voltage level based on a pair of threshold voltages; and
generate a trigger voltage to open the power switch in response to determining that the bus voltage of the single-wire bus is pulled down to the lower bus voltage level.

20. The wireless device of claim 19, wherein the RC circuit comprises:
a capacitor coupled to a ground;
a switch and a first resistor coupled in series between the single-wire bus and the capacitor; and
a second resistor coupled between the single-wire bus and the capacitor and having a larger resistance than the first resistor;
wherein the switch is opened during the transition period and opened outside the transition period.
